(19) United States
(12) Patent Application Publication
(10) Pub. No.: US 2006/0143262 A1
(43) Pub. Date: Jun. 29, 2006

(54) Fast client boot in blade environment

(75) Inventors: Daryl C. Cromer, Apex, NC (US); Howard J. Locker, Cary, NC (US); Randall S. Springfield, Chapel Hill, NC (US); Rod D. Waltermann, Durham, NC (US)

Correspondence Address: IBM CORPORATION (SYL-RPS), C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 11/024,109

(22) Filed: Dec. 28, 2004

(51) Int. Cl. G06F 15/16

(52) U.S. Cl. 709/201

(57) ABSTRACT

The boot-time required for a log-on to a desktop blade system is improved, and a more streamlined process for performing maintenance operations, such as software updates, across an enterprise desktop blade system is facilitated. All activities being performed by a user are cached, in an off-blade storage location, on an ongoing basis. The caching is performed using “divided caching”, that is, different elements of the user image are stored in different locations. The specific divisions utilized are based upon classifications of the information to be cached, e.g., a first class of information used by all users of the system; a second class of information utilized by a certain class of users; a third class of information utilized only by a particular individual, etc.

### BACKGROUND OF THE INVENTION

1. Field of the Invention

This invention relates to management of the boot process of blade computing systems.

2. Description of the Related Art

In the past, information handling systems, e.g., workstations, servers, etc. were essentially self-contained systems within an appropriate housing. For example, a desktop PC would consist of user interface elements (keyboard, mouse, and display) and a tower or desktop housing containing the CPU, power supply, communications components and the like. However, as demands on server systems and PC systems increased and with the increasing spread of networks and the services available through networks, alternate technologies have been proposed and implemented.

Blade computing is one such technology. A blade server provides functionality comparable to or beyond that previously available in a “free standing” or self-contained server, by housing a plurality of information handling systems in a compact space and a common housing. Each server system is configured to be present in a compact package known as a blade, which can be inserted in a chassis along with a number of other blades. At least some services for the blades, typically power supply, are consolidated so that the services can be shared among the blades housed in common. As blade technology has advanced, blade architecture has been developed whereby servers are packaged as single boards and designed to be housed in chassis that provide access to all shared services. In other words, blade servers today are single board units that slide into a slot in a housing in which other like boards are also housed.

While blade server technology changed the way in which servers were utilized and managed, on the client side (e.g., at the desktop level), things remained essentially the same. That is, each workstation still consisted of a desktop PC coupled, wirelessly or via Ethernet cables, to the “server farm” where the blade servers were stored. However, the next logical progression of blade technology was then applied to PCs, resulting in the “desktop blade”.

Similar to server blades, desktop blades involve the configuration of the major components of a PC onto a single card, and then storing/housing many such cards in a single chassis or housing. This allowed the moving of the processing power of the PC into a single location, leaving the workstation user with simply a keyboard, mouse, monitor, and a deskside device (a network port device such as a thin client, fat client, etc.) on the desktop. The deskside device connected the keyboard, mouse and monitor to the desktop blades via standard networking devices/cables, freeing up space in the user's work area.

The use of desktop blades allows centralized management and maintenance of the PC hardware, and enables sharing of hardware so that, for example, an organization with 1,000 employees, but that on the average day has only 900 employees accessing/utilizing PC assets, can choose to purchase and maintain only 900 desktop blades instead of requiring that there be one available for each employee, whether they are present or not. The desktop blades are stateless and are allocated to employees when they log on to the system. Since the desktop blades can be used by different users at different times, each employee's user image is stored off the blade, e.g., in a hard drive separate from the blade, and a log-on management console tool allocates the blade and directs the blade to the appropriate partition in the storage location where the user's image is stored. While this system functions adequately, it can result in slower log-on times, since the entire user image must be stored, for each user, and then retrieved in its entirety, when a particular user logs on. Further, if software updates are being implemented by an administrator, each individual user image must be updated individually.

Accordingly, it would be desirable to have a desktop blade system whereby the time needed to bring up the system is reduced and maintenance of the system, e.g., the implementation of software upgrades, can be performed in a more streamlined fashion.

### SUMMARY OF THE INVENTION

The present invention provides a method, system, and computer program product for improving the boot-time required for a log-on to a desktop blade system. The present invention also enables a more streamlined system for performing maintenance operations, such as software updates, across an enterprise desktop blade system. In accordance with the present invention, all activities being performed by a user during a particular log-on session are cached, in an off-blade storage location, on an ongoing basis. The caching is performed using “divided caching”, that is, so that different elements of the user image are stored in different locations. The specific divisions utilized are based upon classifications of the information to be cached, e.g., a first class of information used by all users of the system; a second class of information utilized by a certain class of users; a third class of information utilized only by a particular individual, etc. This allows selective storage of the various classes of information using storage media that will maximize the use of the particular class of information.

### BRIEF DESCRIPTION OF THE DRAWINGS

FIG. 1 illustrates an exemplary blade environment in which both desktop blades and blade servers are utilized;

FIG. 2 illustrates the overall concept of the present invention;

FIG. 3 is a flowchart illustrating the divided storage process of the present invention; and

FIG. 4 is a flowchart illustrating exemplary steps performed in connection with use of the present invention.

### DETAILED DESCRIPTION OF THE PREFERRED EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

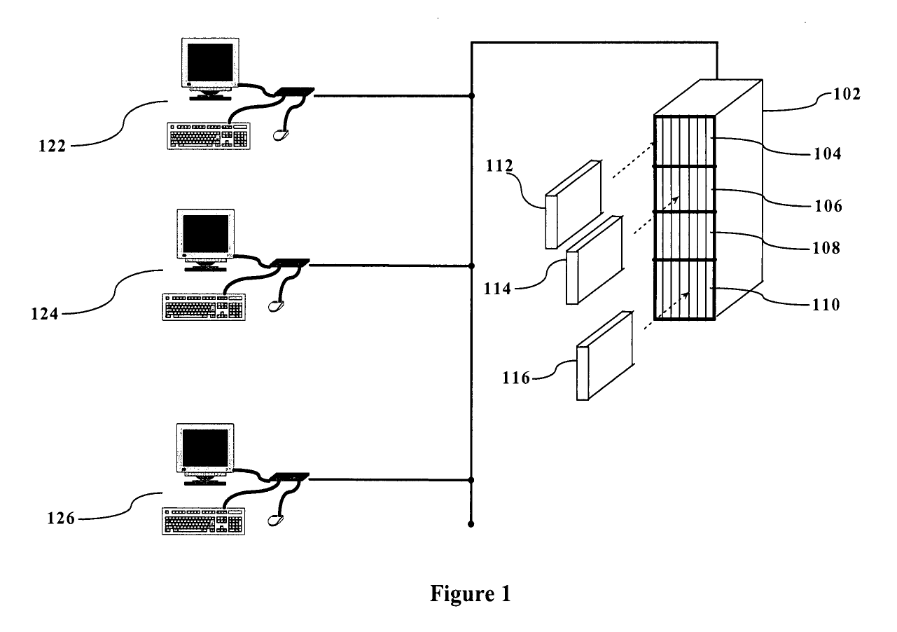

Referring now more particularly to the drawings, FIG. 1 illustrates an exemplary blade environment in which both desktop blades and blade servers are utilized. While the view is simplified and certain elements to be described herein are not visible in FIG. 1, the apparatus is shown to have a rack housing 102 in which are situated a plurality of chassis 104, 106, 108, and 110. Within the chassis, multiple blades, e.g., blades 112, 114, and 116, can be mounted. For example, in FIG. 1, blade 112 is illustrated as being mounted in chassis 104; blade 114 is shown as being mounted in chassis 106, and blade 116 is shown being mounted in chassis 110.

The blades illustrated in FIG. 1 are shown withdrawn from their respective chassis, with an indication that the blades may be inserted into the chassis. In a preferred embodiment, any type of blades can be stored in rack housing 102 and utilized by users via workstations (described below) as needed. For example, blade 112 can be a desktop blade, blade 114 can be a server blade, and blade 116 can be a storage blade (a blade devoted to storage space). It is understood that multiple rack housings may be used to, for example, keep all desktop blades in one rack, all server blades in another rack, and all storage blades in a different rack. However, from a performance viewpoint, it is preferable to have at least a set of desktop blades and the storage blade on which their images are stored all housed in the same rack. It is also understood that an external server can also be used as a storage device instead of, or in addition to, a storage blade.

The rack housing 102 may also house a management module (not shown) for managing the flow of data to and from the blades, as well as to storage locations such as hard drives, ROM and the like. It is understood that, while a single rack housing 102 is illustrated, multiple rack housings may be interconnected in a single “blade center” and operate as essentially one chassis as shown. Further, although not shown, common elements, such as power supplies, a management module, cooling fans, etc. may also be included in rack housing 102.

Connected to rack housing 102 are workstations 122, 124, and 126. It is understood that although only three workstations are shown in FIG. 1, a single workstation or many more than three workstations may be attached to rack housing 102 in the manner shown in FIG. 1. In a typical desktop blade setup, the connection between workstations 122, 124, 126, and rack housing 102 is via an Ethernet connection. It is understood that any method of connecting the desktop stations to the blades in the rack housing may be utilized.

Workstations in a blade environment typically comprise a display device (e.g., a CRT) and user interface devices such as a keyboard and mouse. A deskside device (a network port device, such as a “thin client”, fat client, etc.) connects the keyboard, mouse and monitor to the desktop blades. The deskside device extracts video data from the signal it receives from the desktop blade via the Ethernet connection and drives the display with this video data. In addition, the desktop device takes keyboard and mouse input, packetizes it, and transmits it over the Ethernet connection to the desktop blade in rack housing 102.

In a typical desktop blade system such as that shown in FIG. 1, when a user logs on at a workstation, e.g., at workstation 122, that user will activate a log-on process whereby they identify themselves to the system and “request” the allocation of a blade to them for use. It is understood that this request is essentially transparent, i.e., the user does not have to specifically submit a request for the blade, but instead, the act of logging on indicates to the system that the user is in need of a blade for use. Upon providing identifying information to the system, a management module (or a discrete server on the Ethernet configured for the same purpose) allocates a blade to the user and identifies the location where the user's user image is stored, e.g., on storage blade 116. The user's user image is then directed to the particular workstation where the user is logging on, essentially bringing the user back to the state that he or she was in when they logged off. It is understood that the term “log-off” includes an active log-off, whereby the user signs off the system, as well as a passive log-off, for example, when the user ceases of the system for a predetermined period of time, thereby placing the desktop workstation in a “hibernation” mode or other essentially-suspended state. Thus, a first user of a desktop blade system such as that illustrated in FIG. 1 logs off the system (or is logged off), thereby releasing the blade that was being used at the time for use by a second user. When the first user logs back on again, a different blade is allocated to the first user, and they are returned to essentially the same place they were when they logged off.

In order to achieve this reinstatement of the user image, upon logging off the system, the blade system of the prior art stores the entire user image of the user in an off-blade location (i.e., off the particular desktop blade) such as a storage blade or other memory storage device.

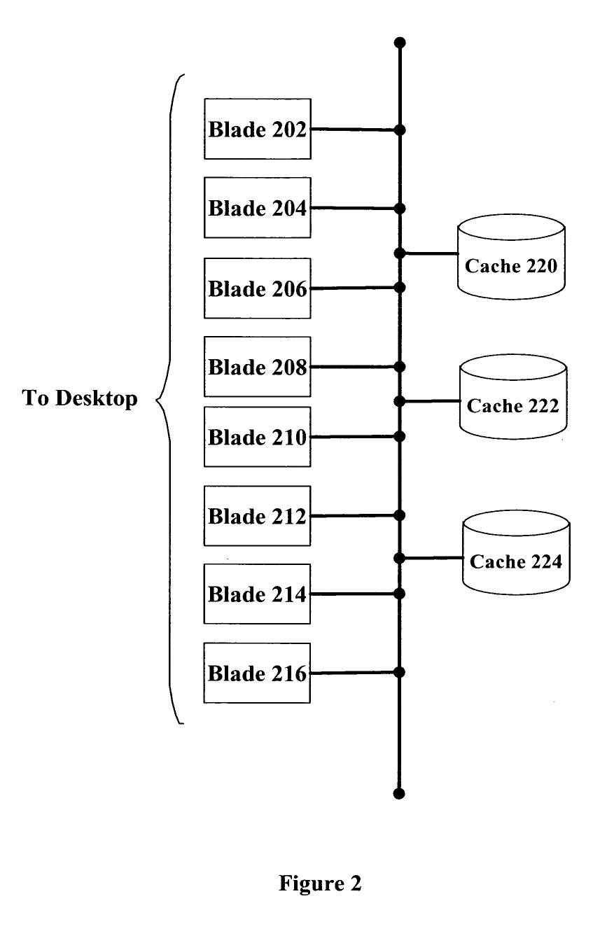

FIG. 2 illustrates the overall concept of the present invention. Referring to FIG. 2, multiple desktop blades 202, 204, 206, 208, 210, 212, 214, 216 are illustrated being connected to multiple storage devices 220, 222, and 224. It is noted that, while three separate storage devices are illustrated, many more storage devices may be utilized, or a single storage device with “virtual memory locations” allocated thereon can also be used. The connection between the blades 202-216 and workstations are essentially identical to that shown in FIG. 1 and are thus not shown herein. Further, it is understood that blades 202-216 can be in a single chassis, or in multiple chassis interconnected by, for example, Ethernet connections.

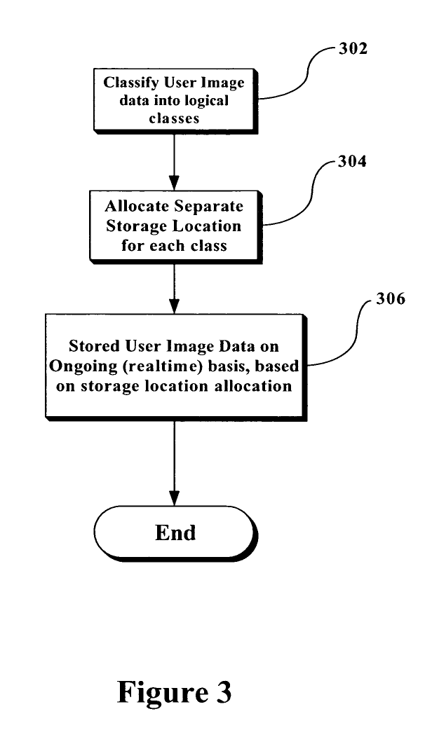

The process of the present invention, in connection with the structure illustrated in FIG. 2, is now described with respect to FIG. 3. FIG. 3 is a flowchart illustrating the divided storage process of the present invention. Referring to FIG. 3, at step 302, the user image data of each user on the system is classified into logical classes. For example, a user's user image data might be divided into a first class comprising operating system software/data that is utilized identically by every user of the enterprise system. This could be, for example, the Windows XP operating system utilized by all users of the system. A second class of user image data might comprise portions of the operating system data utilized commonly by a particular subclass of the users of the enterprise and/or applications that are typically used by one or more of the end users and which run on top of the operating system (e.g., Microsoft Office, Lotus Notes, etc.). For example, if all users from an engineering department utilize the same “home page” on a corporate intranet that gives them access to engineering tools, engineering announcements, engineering applications, etc., then this software/data can be classified as such and stored in a second storage location. A third class of data, e.g., software/data utilized only by the particular user, can be classified as such and stored in a third storage location. This class would include the unique user data files and application programs licensed for use only by a particular user. The process used to divide the software/data by class will be apparent to one or ordinary skill in the art and it not discussed further herein.

At step 304, the separate storage locations are allocated for each class of data. At step 306, the user's image data is stored, e.g., in an ongoing (realtime) basis and/or at logoff, into the appropriately allocated storage areas. Since the first class of software/data described above (called “class 1 data” in this example) is utilized by all users of the system, this can be saved in a single storage location, rather than having to store individual versions for each user as is done in the prior art.

The second class of data (called “class 2 data” in this example), which is data/applications used by a subclass of all users, can be stored in a location that makes it most easily accessible to that subclass, and again, since there is a large group of users (the subclass) using this data, a single storage location can be utilized for access by all members of that subclass. The subclass may comprise all users, but typically would comprise less than all users.

Finally, the software/data that is unique to the particular user (“class 3 data” in this example) can be allocated to a user-specific partition, just as is done in the prior art.

In addition to allowing shared storage for commonly used software/data, software/data that must be accessed quickly, e.g., operating system software, can be stored in a faster storage device than that used for software/data that does not need to be accessed as quickly (e.g., user data). This further enhances the efficiency of the present invention.

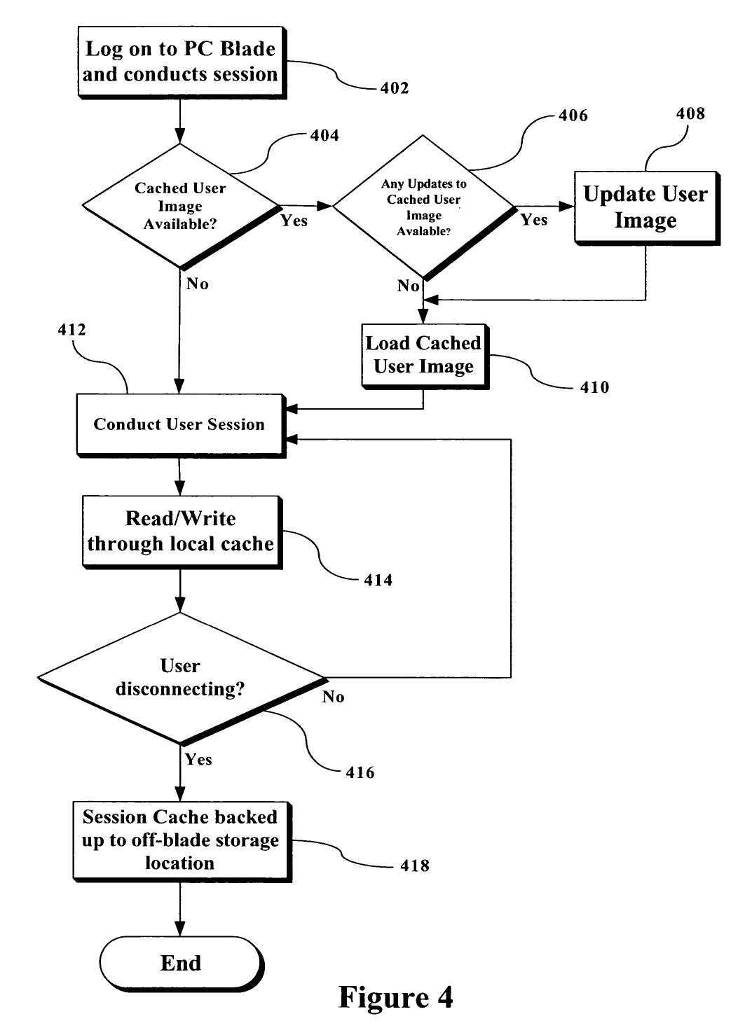

FIG. 4 is a flowchart illustrating exemplary steps performed in connection with use of the present invention. Referring to FIG. 4, at step 402, a user logs on to a desktop blade at a desktop station to conduct a session. At step 404, based upon the user's log-on, it is determined whether or not a cached user image is available for that user. For example, if class 3 data is found indicating the existence of a user image, this class 3 data is loaded. Since a cached user image is available for that user, the process proceeds to step 406, where the class 1 and class 2 data associated with the user image is checked for available updates.

If updates are available, the process proceeds to step 408, where the updatable elements of the user image are updated, and then the process proceeds to step 410 where the remainder of the cached user image (the class 1 and class 2 data in this example) is loaded and then the user session begins at step 412. If, at step 406, there are no updates to the cached user image, the process proceeds directly to step 410 (where the remainder of the user image is loaded as described above) and on to step 412.

If at step 404 it is determined that there is no cached user image available, the process proceeds directly to step 412 for the conducting of the user session. Without a user image from which to draw particularized user information, this “generic logon” involves the loading of a common image (i.e., essentially identical to the class 1 data described above, e.g., operating system and perhaps a generic shell, GUI screen, or other menu-like interface). At step 414, during the user session, read/write operations are performed through the local cache to store on an ongoing basis, image data to off-blade (i.e., off the desktop blade) storage.

At step 416, a determination is made as to whether or not the user is disconnecting from the system. This could be, for example, through an active log-off or a passive log-off as described above. If, at step 416, it is determined that no user disconnect operations are being performed at this time, the process continues back to step 412 for a continuance of the user session.

If, at step 416, it is determined that the user is disconnecting, then the process proceeds to step 418, where the entire session is backed-up to the off-blade storage locations. As described above, the storage is performed on a divided basis, based upon the classifications of software/data being used by the user and making up the user's image. The process then ends.

By using the above-described system, the start-up costs involved with respect to constructing a user's data from a distributed storage medium, which costs can be quite large as each part of the user's image is collected and reconstructed into a consolidated image of the user's data, are greatly reduced. Using the present method, the user's image is constructed on-the-fly and is thus always available for loading upon reconnection. This is a performance improvement over a typical desktop blade which requires a complete reboot, a time-consuming process that does not put the user back in the same state from which they left. It is different than a normal S4 memory dump in that it may include files, or partial files, that are not currently loaded in memory.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage on a disk drive located in a rack housing. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 2-4 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of storing image information pertaining to user images, comprising the steps of:
classifying the image information into two or more logical classes;
associating separate storage locations with each logical class; and
storing said image information using divided caching, whereby each logical class of image information is stored in its associated storage location.

2. The method of claim 1, wherein said separate storage locations comprise at least two disparate physical storage locations.

3. The method of claim 2, wherein:
a first of said user images corresponds to a first user of a desktop blade in a blade computing system;
a first class of said image information comprises operating system files used by all users of said blade computing system; and
said first class of image information is stored on a storage blade local to desktop blades accessible to said first user.

4. The method of claim 3, wherein:
a second class of said image information comprises a set of application files selectively useable by one or more users of said blade computing system; and
said second class of image information is stored on a storage location accessible to said one or more users.

5. The method of claim 4, wherein:
a third class of said user image information comprises user files used by a single user of said blade computing system, said third class of said user image information being stored in any storage location accessible to said single user.

6. A system of storing image information pertaining to user images, comprising:
means for classifying the image information into two or more logical classes;
means for associating separate storage locations with each logical class; and
means for storing said image information using divided caching, whereby each logical class of image information is stored in its associated storage location.

7. The system of claim 6, wherein said separate storage locations comprise at least two disparate physical storage locations.

8. The system of claim 7, wherein:
a first of said user images corresponds to a first user of a desktop blade in a blade computing system;
a first class of said image information comprises core operating system files used by all users of said blade computing system; and
said first class of image information is stored on a storage blade local to desktop blades accessible to said first user.

9. The system of claim 8, wherein:
a second class of said image information comprises a set of application files selectively useable by one or more users of said blade computing system; and
said second class of image information is stored on a storage location accessible to said one or more users.

10. The system of claim 9, wherein:
a third class of said user image information comprises user files used by a single user of said blade computing system, said third class of said user image information being stored in any storage location accessible to said single user.

11. A computer program product for storing image information pertaining to user images, the computer program product comprising a computer-readable storage medium having computer-readable program code embodied in the medium, the computer-readable program code comprising:
computer-readable program code that classifies the image information into two or more logical classes;
computer-readable program code that associates separate storage locations with each logical class; and
computer-readable program code that stores said image information using divided caching, whereby each logical class of image information is stored in its associated storage location.

12. The computer program product of claim 11, wherein said separate storage locations comprise at least two disparate physical storage locations.

13. The computer program product of claim 12, wherein:
a first of said user images corresponds to a first user of a desktop blade in a blade computing system;
a first class of said image information comprises core operating system files used by all users of said blade computing system; and
said first class of image information is stored on a storage blade local to desktop blades accessible to said first user.

14. The computer program product of claim 13, wherein:
a second class of said image information comprises a set of application files selectively useable by one or more users of said blade computing system; and
said second class of image information is stored on a storage location accessible to said one or more users.

15. The computer program product of claim 14, wherein:
a third class of said user image information comprises user files used by a single user of said blade computing system, said third class of said user image information being stored in any storage location accessible to said single user.
